(19) United States
(12) Patent Application Publication
(10) Pub. No.: US 2002/0119415 A1
(43) Pub. Date: Aug. 29, 2002

(54) Lighted air/water syringe

(75) Inventor: Ronald Bailey, Harvester, MO (US)

Correspondence Address: POLSTER, LIEDER, WOODRUFF & LUCCHESI, 763 SOUTH NEW BALLAS ROAD, ST. LOUIS, MO, 63141-8750, US

(73) Assignee: Young Dental Manufacturing Company

(21) Appl. No.: 09/873,837

(22) Filed: Jun. 4, 2001

Related U.S. Application Data
(60) Provisional application No. 60/271,082, filed on Feb. 23, 2001.

(51) Int. Cl. A61C 17/00

(52) U.S. Cl. 433/80

(57) ABSTRACT

A lighted air/water syringe includes a head mounted on a sleeve via a neck. The sleeve includes an air supply line, a water supply line, and a light tube which are connected to sources of air, water, and light by a supply conduit. The air and water passages are in communication with the air and water lines in the sleeve and extend through the neck to a front of the head. Valves are positioned in the air and water passages to selectively regulate the flow of air and water to the end of the head. The light tube in the sleeve extends through the neck and partially into the head. The head removably receives a probe or nozzle in its end. The probe is made from a light transmitting material, and, when placed in the head, is in light transmitting communication with the light tube. The probe includes air and water passages having entrances in the side of the probe and exits at a forward surface of the prove. The side entrances are placed in fluid communication with the air and water passages in the head when the probe is inserted in the head. A method of making the probe is also disclosed.

### CROSS REFERENCE TO RELATED APPLICATIONS

This application claims priority to Provisional Application Ser. No. 60/271,082, filed Feb. 23, 2001, entitled “Lighted Air/Water Syringe”, and which is incorporated herein by reference.

### STATEMENT REGARDING FEDERALLY SPONSORED RESEARCH OR DEVELOPMENT

Not Applicable.

### BACKGROUND OF THE INVENTION

This invention relates to air/water syringes for use by dentists, and in particular, to a lighted air/water syringe.

Dentists commonly use air/water syringes during various procedures to clean the work area of tooth debris or other debris. For example, after a dentist performs a drilling operation, he will remove the debris with a water spray. Dentists also use the air spray to dry a tooth surface after rinsing or cleaning, for example, to apply a coating to the tooth surface. Typically, the air/water syringes allow the dentist to spray streams of air and water either individually or together. However, conventional air/water syringes only operate to spray air and water. They do not provide any lighting to enable the dentist to see the working area more clearly while he is cleaning out the work area, or after he has cleaned out the work area.

Further, the probe or nozzle of the air/water syringe is typically made of metal, and hence must be sterilized between uses. This requires that the dentist have several different nozzles, so that the nozzles can be switched between patients to ensure that a clean nozzle is used on each patient. If the syringe does not allow for the nozzle to be removed, the dentist must resort to washing the nozzle off. However, the dentist can only wash off (or wipe down) the outside of the syringe. If any of the patient's saliva or debris is pulled into the syringe (for example when the syringe valve are closed), the dentist can blow this saliva or debris out of the syringe, but he will not be able to effectively clean the inside of the syringe nozzle without fully sterilizing the nozzle.

### BRIEF SUMMARY OF THE INVENTION

An air/water syringe is provided. The syringe has a head mounted on a sleeve via a neck. The head is generally circular in lateral cross-section, and has generally curved or arced surfaces in axial cross-section. The head has a generally sloped back surface and a generally vertical front surface. A nozzle or probe is removably received in the front of the head. Push button actuators are provided on the back surface provide an air and/or water spray at a desired location in a patient's mouth.

The sleeve has an air supply line, a water supply line, and a light tube which are connected to sources of air, water, and light in a control by a supply conduit. The neck has air and water passages and a central opening. The neck and air water passages are in fluid communication with the air and water lines of the sleeve and exit the sleeve in a side surface of the sleeve. The light tube in the sleeve passes through the neck central passage.

The head includes air and water valve chambers which extend from the back surface of the head and which are in communication with the air and water passages of the neck. The valve chambers are offset from both a vertical and horizontal plane of the head and are angled or sloped downwardly and outwardly. The bottom portion of the chambers are disposed on opposite sides of the neck, the neck being received substantially in the center of the head, and the exit ports on the side of the neck open into the respective valve chambers at the bottoms of the valve chambers. Air and water passages extend forwardly from upper portions of the valve chambers and are in communication with the probe or nozzle, as discussed below. Valve members are received in the valve chambers to open and close the head passages to permit and prevent the flow of air and water to the nozzle. The head also includes a central passage way into which the light tube extends.

The valves each include a body having a button external of the head, a neck depending from the head, a sloped section depending from the neck, and a generally straight sided section depending from the sloped section. The straight-sided section has a width substantially equal to the width of the chamber. The valve body is movable between a first raised position in which the valve body straight sections block the entrance from the valve chambers to the head passages and a second lowered position in which the conical sections are in fluid communication with ports between the neck passages and the chamber lower sections to place the neck passage and the head passage in fluid communication with each other so that air and water can exit the nozzle. The valve bodies are normally biased to their first, raised, positions by pressure in the neck air and water passages.

The head also includes a forward chamber which opens into the central passage way. The probe or nozzle is received in the chamber. The nozzle is made of light transmitting material, such as polycarbonate, and includes air and water passages which extend from entrance ports in the side of the nozzle to exits at the end of the nozzle. The nozzle is removably received in the chamber and is frictionally held in place in the chamber to be in light transmitting communication with the light tube in the head. The chamber's inner surface has a first annular channel in fluid communication with the head water passage and a second annular channel in fluid communication with the head air passage, and seals on opposite sides of the first and second annular channels. When the nozzle is inserted into the chamber, the entrance ports to the nozzle passages are placed in fluid communication with their respective annular channels. The seals not only form fluid seals with the nozzle around the annular channels, but frictionally grip the nozzle to hold the nozzle in the chamber. Thus, the seals can either be ribs on the inner surface of the chamber or O-rings received in grooves in the inner surface of the chamber. The chamber inner surface can be formed directly in the head. Alternatively, the head can receive a hollow sleeve in a forward opening of the head. This sleeve would then define the chamber inner surface and would include passages which place the annular channels in communication with their respective passages in the head.

The probe is made from a lens quality polycarbonate and is disposable. The probe is made by cutting an extruded piece of the polycarbonate to length. The polycarbonate is extruded with the air and water passages in it. After the length of the extrusion has been cut, one end of the cut length is sealed to close off the passages at that end and the entrance ports to the passages are formed in the side of the probe. The material used to seal the end of the probe has substantially the same refractive index as the extruded material.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a perspective view of a lighted air/water syringe of the present invention;

FIG. 2 is a rear elevational view of the air/water syringe;

FIG. 3 is a cross-sectional view of the air/water syringe taken along line 3-3 of FIG. 2;

FIG. 4 is a cross-sectional view of the air/water syringe taken along line 4-4 of FIG. 2;

FIG. 5 is bottom plan view of the head of the air/water syringe, with internal holes shown in phantom;

FIG. 6 is side elevational view of the head with internal holes and passages shown in phantom;

FIG. 7 is a cross-sectional view of the head taken along line 7-7 of FIG. 5;

FIG. 8 is a cross-sectional view of the head taken along line 8-8 of FIG. 5;

FIG. 9 is an exploded view of the head and a valve assembly for the head;

FIG. 10 is a perspective view of a neck of the air/water syringe;

FIG. 11 is a side elevational view of the neck;

FIG. 12 is a back elevational view of the neck;

FIG. 13 is a cross-sectional view of the neck taken along line 12-12 of FIG. 11;

FIG. 14 is a cross-sectional view of the neck taken along line 14-14 of FIG. 11;

FIG. 15 is a side elevational view of a nose of the air/water syringe;

FIG. 16 is a back elevational view of the nose;

FIG. 17 is a cross-sectional view of the nose taken along line 17-17 of FIG. 16;

FIG. 18 is a cross-sectional view of the nose taken along line 18-18 of FIG. 15;

FIG. 19 is a cross-sectional view of the nose taken along line 19-19 of FIG. 16;

FIG. 20 is a side elevational view of a disposable probe of the air/water syringe;

FIG. 21 is an front end elevational view of the probe; and;

FIG. 22 is a cross-sectional view of an alternative head for the air/water syringe.

Corresponding reference characters indicate corresponding parts throughout the several views of the drawings.

### DETAILED DESCRIPTION OF THE INVENTION

The following detailed description illustrates the invention by way of example and not by way of limitation. This description will clearly enable one skilled in the art to make and use the invention, and describes several embodiments, adaptations, variations, alternatives and uses of the invention, including what we presently believe is the best mode of carrying out the invention.

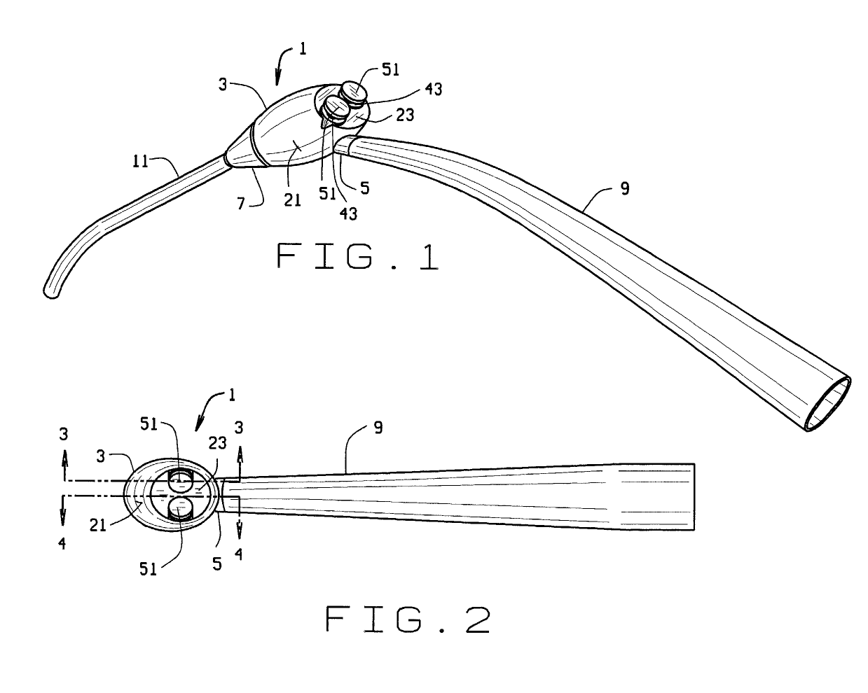

An air/water syringe 1 of the present invention is shown generally in FIGS. 1-4. The air/water syringe 1 includes a body 3 having a neck 5 and a nose 7 (which in combination define a head 8). The neck 5 is received in a handle or sleeve 9 which carries water and air lines, and an optic tube (such as a bundle of optic fibers). The sleeve 9 has a connector at its end which connects the sleeve to a supply conduit, which extends from a control unit, or otherwise connects the syringe 1 to a source of air, water, and light. The connector is preferably a swivel connector, such as shown in co-pending application Ser. No. 60/272,513 filed Feb. 23, 2001, entitled SWIVEL CONNECTOR FOR A DENTAL AND MEDICAL HANDPIECE, and which is incorporated herein by reference. A disposable probe or nozzle 11 is removably received in the nose 7 to delivers air, water, and light to a desired spot in a patient's mouth. As will be described below, the syringe 1 can be operated to deliver only air, only water, or a combination of air and water.

The body 3 is generally in the shape of a truncated football or oval. It includes an outer side surface 21, a back surface 23, and a front 25. The front surface 25 is formed generally perpendicularly to an axis A1 (FIG. 6) of the body 3. The back surface 23, however, is formed at an angle α (of about 120°) to the axis A1, as seen in FIG. 6. A pair of valve chambers 27 and 28 extend inwardly from the back surface 23. The valve chambers 27 and 28 include a first section 27a and 28a and a second section 27b and 28b. The two sections (27a, 28a and 27b, 28b) are both generally cylindrical in shape, with the second section 27b., 28b being of a smaller diameter than the section 27a, 28a. The chambers 27 and 28 are not parallel to an axis A2 (FIG. 5) of the body 3; nor are the axis of the two chambers parallel to each other. Rather, the axes of the chambers 27 and 28 form an angle β of about 14° with the axis A2, and an angle Δ of about 28° with each other. Further, the chambers 27 and 28 are not parallel to the axis A1 (FIG. 6). Rather, they form an angle of about 30° with the axis A1. Thus, as can be seen in FIGS. 5 and 6, the chambers 27 and 28 angle downwardly and outwardly from the back wall 23.

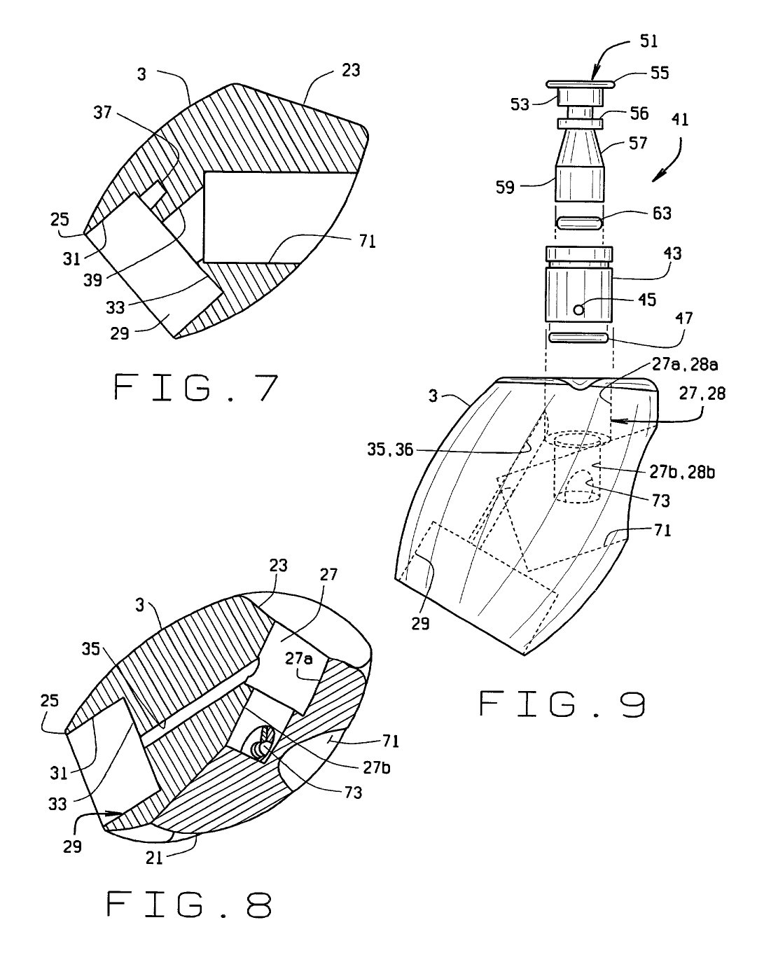

A nose opening 29 is formed in the body front surface 25. The opening 29, as described below, is sized to frictionally receive the nose 7. The opening 29 has a side wall 31 and a floor 33. Passages 35 and 36 extend from the nose opening floor 33 to the chambers 27 and 28, respectively, to place the chambers 27 and 28 in fluid communication with the nose opening 29. The passages 35 and 36 intersect the chambers 27 and 28 near the base of the chambers sections 27a and 28a. The passages 35 and 36 are spaced apart on the nose opening floor 33 by about 180°. A pin hole 37 is positioned radially between the passages 35. Additionally, a central opening 39 (FIG. 7) extends rearwardly from the nose opening floor 33.

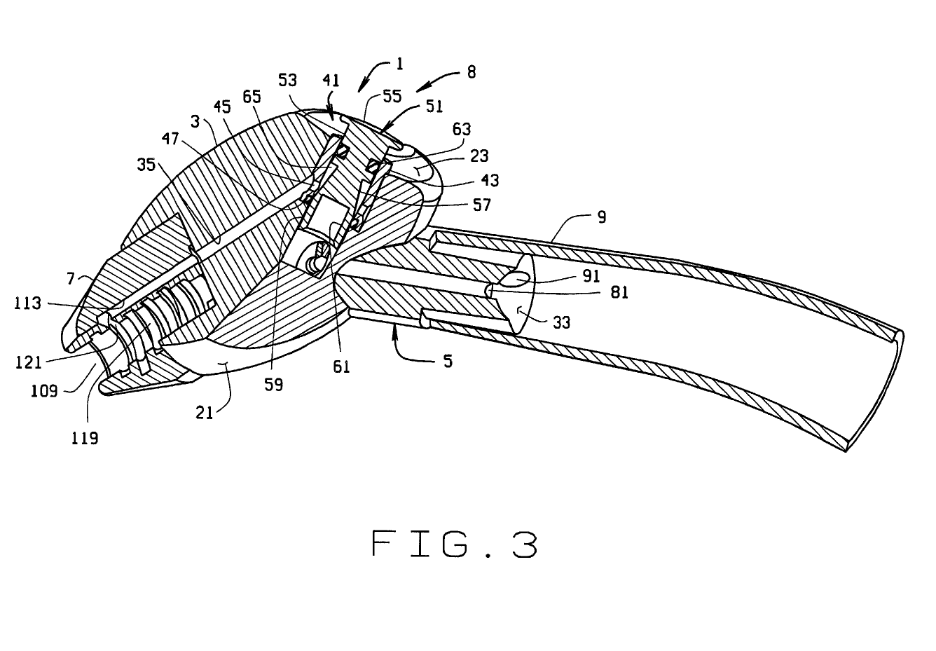

A valve assembly 41 (FIG. 9) is received in each of the chambers 27 and 28. The valve assemblies each include a sleeve 43 which is received in the chamber section 27a, 28a. The sleeves 43 have inner diameters which are approximately equal to the diameters of the chamber lower section 27b. The sleeves 43, as seen in FIGS. 3 and 9, extend slightly above the body back surface 23. The sleeves each include a port 45 which, when the sleeve is inserted in the passage 27a, is in alignment with the body passages 35 and 36. Hence, the interior of the sleeves 43 are in communication with the body nose opening 29 by way of the passages 35 and 36. A groove on an inner surface of the sleeve, below the port 45, receives an O-ring 47 (FIG. 3).

A plunger or actuator 51 is received in the sleeve 43. The plunger 51 includes a neck 53 having an external head 55 which is adapted to be depressed by an operator's thumb. A groove 56 on the neck 53 receives an O-ring 63. The neck 53 has a diameter slightly less than the inner diameter of the sleeve 43, so that the neck 53 can move axially relative to the sleeve 43. The O-ring 63 forms a fluid and air tight seal between the plunger neck 51 and the sleeve 43. A conical section 57 extends from the bottom of the neck 53. The conical section 57 has an upper diameter that is less than the inner diameter of the sleeve 43 and chambers 27b 28b, and a lower diameter that is slightly less than the inner diameter of the sleeve 43 and chambers 27b, 28b. A cylindrical section 59 extends from the bottom of the conical section 57. The cylindrical section 59 has a diameter slightly less than the diameter of the chamber section 27b, and wipes against the O-ring 47 in the sleeve 43 to form a fluid tight seal with the O-ring. A cup 61 is formed in the bottom of the plunger conical section 59.

The plunger 51 has an overall length that is greater than the sleeve 43, and, when placed in the sleeve 43, extends into the respective chamber section 27a, 28a. The plunger 51 is movable between a raised position and a lowered position. In the raised position, the plunger bottom conical section 59 closes the passages 35 and 36, as seen in FIG. 3. The conical section 57 defines a channel 65 with the sleeve. When the plunger 51 is pressed down, the conical section 57 comes into alignment with the passages 35 and 36 to place the channel 65 in communication with the passage 35. As will be explained more fully below, the plunger is biased to its upward position by fluid pressure.

A neck opening 71 is formed in the bottom of the body 3. The bottom opening is sized to receive the neck 5. The bottom opening 71, and the central opening 39 in the body front opening intersect, as seen in FIG. 7. As seen in FIG. 8, the chambers 27b, 28b also intersect with the bottom opening 71, defining ports 73 on opposite sides of the opening 71. When the plunger 51 is depressed, the channel 65 defined by the plunger conical section 57 is in communication with the ports 73 in addition to the passages 35 and 36.

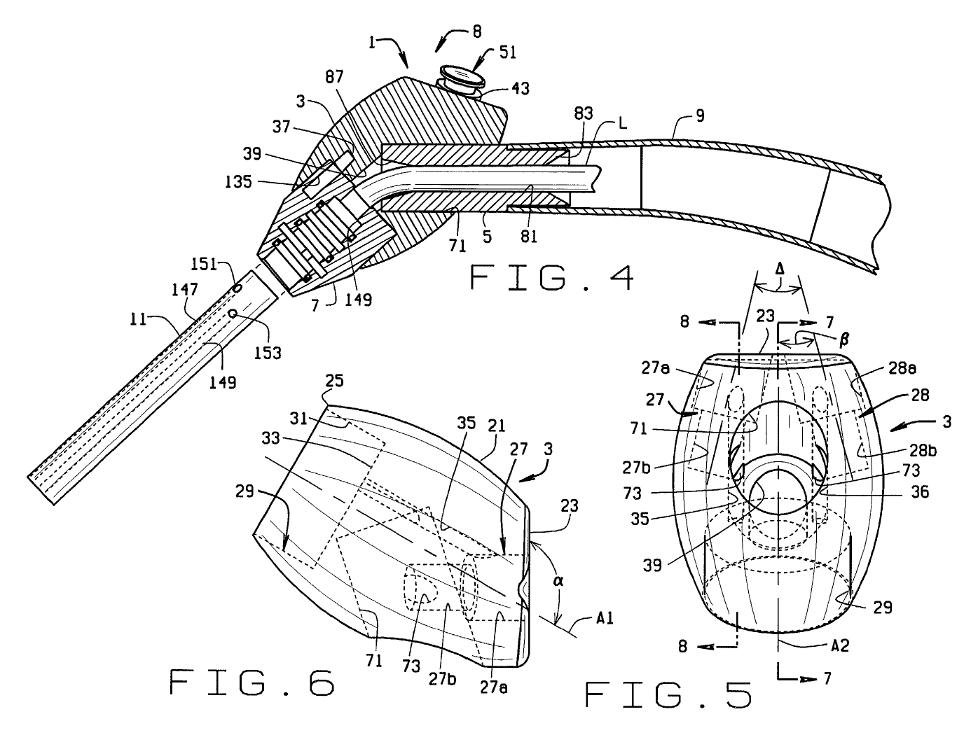

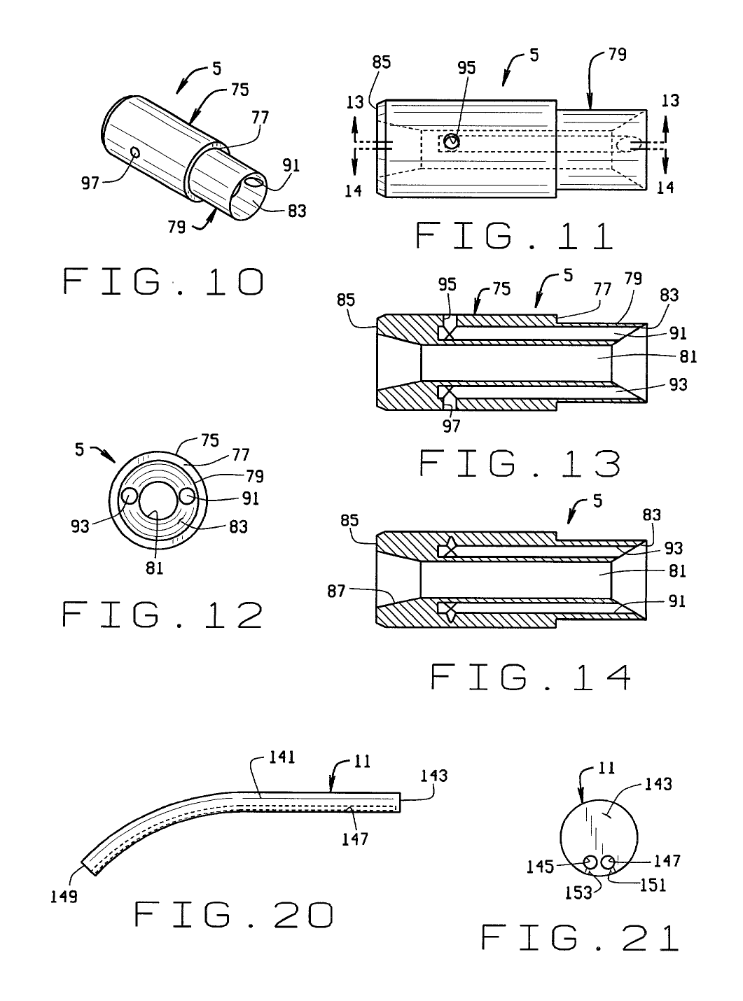

The neck 5, shown in FIGS. 10-14, include a forward portion 75 which is sized and shaped to be frictionally received in the syringe body opening 71. The neck 5 is stepped down as at 77 to form a back portion 79. The back portion 79 is sized and shaped to be frictionally received in the sleeve 9. As seen in FIG. 4, the forward portion 75 of the neck 5 extends to the end of the opening 71 and extends out of the body 3 such that a portion of the forward portion 75 is exposed. The sleeve 9 covers the neck's back portion 79 and buts against the shoulder or step 77.

The neck 5 includes three passages. A central passage 81 extends from the back surface 83 of the neck and exits at the front surface 85 of the neck. The back surface 83 is generally conical in shape. The passage 81 is sized and shaped to receive the light tube L which is in the sleeve 9. At its forward end, the central passage 81 has a sloped surface 87, and increases in diameter. The neck also includes an air passage 91 and a water passage 93 which extend on opposite sides of the central passage 81 from the neck back surface 83 through the neck back portion 79 and a portion of the front portion 75. The passages 91 and 93 do not extend all the way through the neck. Rather, they exit the neck along the side surface of the neck and form exits ports 95 and 97, respectively, in the neck front portion 75. When the neck 5 is inserted in the body opening 71, the neck central passage 81 opens into the body opening 39. The exits 95 and 97 for air and water passages 91 and 93 align with the ports 73 to open into the chambers 27b, 28b. Hence, the air and water passages 91 and 93 are in fluid communication with the passages 35, 36 in the syringe body 3, by way of the chambers 27b and 28b.

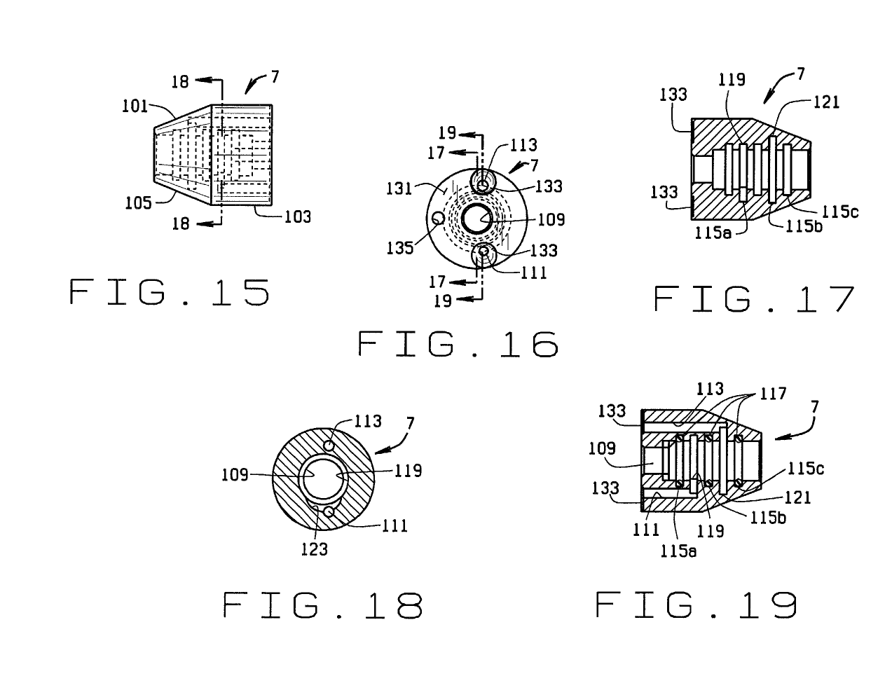

The nose 7, shown in FIGS. 15-19, includes a nose body 101 having a cylindrical back portion 103 and a frustoconical front portion 105. The back portion 103 is sized and shaped to be frictionally received in the body nose opening 29. Internally, the nose 7 includes a central passage 109 and a pair of side passages 111 and 113. Three spaced apart annular grooves 115a,b,c are formed in surface of the central passage 109. O-rings 117 are received in the grooves 115a-c. An annular channel 119 is formed between the grooves 115a and 115b; and another annular channel 121 is formed between the grooves 115b and 115c. The annular channel 121 has a larger diameter than the channel 119. A cutout 123 (as seen in FIG. 18) is formed in each of the channels 119 and 123. The passages 111 and 113 extend through the nose body 101 and open into the cutouts 123 for the channels 119 and 123, respectively. When the nose 7 is inserted in the body hole 31, the nose central passage 109 is aligned with the body opening 39, and hence, is in communication with the neck central passage 81. The air and water passages 113 and 111 of the nose are aligned with the body passages 35 and 36, and hence, are in communication with the neck air and water passages 91 and 93 by way of the chambers 27b, 28b and the valves 41. Preferably, the back surface 131 of the nose body 101 is countersunk as at 133 around the passages 109 and 111 to receive an O-ring to form a fluid tight seal between the nose 7 and floor 33 of the syringe body opening 29. Additionally, the nose 7 includes a pin hole 135 which aligns with the body pin hole 37. A pin is received in the pin holes, to properly orient the nose 7 in the body nose opening 29 when the syringe 1 is assembled so that the nose passages 111 and 113 are aligned with the body passages 35 and 36. The nose 7 and body opening 39 could be provided with a rib and groove, respectively, or could otherwise be shaped or keyed so that the nose 7 can fit into the body 3 in only one rotational orientation, so that the nose passages 111 and 115 will properly line up with their respective counterparts 25 and 36 in the body 3 when the nose 7 is inserted in the body 3

Lastly, the probe or nozzle 11 is sized and shaped to be received in the nose central passage 109. The probe 11 (shown in FIGS. 20-21) includes an outer surface 141, a back surface 143, and a front surface 145. An air passage 147 and a water passage 145 extend through the probe 11 and exit at the front surface 145. The entrances 151 and 153 to the passages 147 and 145, respectively, are near the back of the probe and in the side surface 141 of the probe, rather than in the back surface 143. The back surface 143 is solid. The entrances 151 and 153 to the air and water passages of the probe are positioned on the probe to be aligned with the annular channels 119 and 121, respectively, of the nose 7 when the probe is inserted in the nose. Thus, the probe air passage 159 is in fluid communication with the neck air passage 91 and the probe water passage 161 is in fluid communication with the neck water passage 93 by way of the body valve chambers 27a, 28a and passages 35 and 36. The probe 11 is sized to seal against the O-rings 117 in the nose annular grooves 115a-c, to thereby form fluid tight seals around the annular channels 119 and 121 in the nose. Thus, there should be no intermixing of air and water in the syringe body, nose or probe.

Air and water enter the probe 11 radially, through the side of the probe, rather than axially, through the back end of the probe. Because air and water enter the probe radially, they do not exert an axial force on the probe which would tend to force the probe out of the nose 7. Thus, the probe can simply be frictionally held in the nose. There is no requirement for a shoulder, lock, or some other structure which positively holds the probe in the nose against the force of the air and water.

To operate the air/water syringe 1, one or both of the buttons 51 are depressed. When the button 51 is depressed, the ports 73 in the valve chambers 27b, 28b will be placed in fluid communication with the valve chambers 27a and 28a by way of the annular channel 65 defined by the plunger conical section 57. Hence, the ports 73 between the neck 7 and the valve chambers 27b, 28b will be placed in communication with the ports 45 in the valve sleeves 43, the respective body passages 35, 36, the respective nose passages 111 and 113, and the respective probe passages 147 and 149. The air and water pressure in the neck passages 91 and 93 is positive. Thus, when the valve plungers 51 are released, the pressure in the lines will force the plungers upwardly to block the ports 45 in the valve sleeves 43, and hence close the valves 41.

The probe or nozzle 11 is made of a light transmitting material, such as a lens quality polycarbonate. The back surface 143 of the probe 11 buts against a shoulder 149 in the nose central passage 109 to be in light transmitting communication with the light tube L which extends into the body central passage 39. Thus, the light transmitted through the light tube L will be transmitted to the end of the probe 11, so that a dentist or hygienist can direct light at a desired location in a patient's mouth. The light transmitting capabilities of the probe 11 allow for the dentist or hygienist to light the area that is being rinsed or sprayed with air and/or water. Alternatively, the probe can be used simply to light an area in a patient's mouth. The connection of the probe 11 to the nose 7 allows for the probe 11 to be rotated to any rotational position relative to the nose, all without affecting delivery of air or water to the patient's mouth. This ability to rotate the probe 11 relative to the nose 7 increases a dentist's or hygienist's ability to direct light, air, and water to desired locations in the patient's mouth.

The light probe 11 is preferably cut from an extruded length of material in which the two passages 151 and 153 are already formed. The entrances 151 and 153 to the passages are formed at the desired location in the side surface 141 of the probe 11, for example, by drilling. As can be appreciated, when the extruded material is cut to length, the passages extend completely through the probe. The back end of the passages are sealed or closed by dipping the probe into a light curable material which cures to be transparent and to have substantially the same refractive index as the material from which the probe is made. The light curable material is pulled slightly into the passages by capillary action. The material is cured, for example, by using an infrared light, to complete the probe. The back end of the probe 11 can be sealed either before or after the entrances 151 and 153 to the passages 111 and 113 are formed.

As can be appreciated, the probe 11 is disposable. A new probe 11 is inserted into the nose 7 for each patient. The length of the probe is sufficiently long such that if any air or water is sucked back into the probe when the valves are closed, the air or water will be in the probe, and will not reach the nose passages 111 or 113. Hence, the head (i.e., the body, nose, and neck) of the syringe can be wiped down, for example, with alcohol, between patients. Further, the head of the air/water syringe is all metal (expect for the O-rings in the nose) and can easily withstand repeated sterilization.

Additionally, the air/water syringe 1 does not depend on a light bulb in the body or head of the syringe. Rather, the syringe 1 relies on a light source, for example from a control box. A light tube extends through a supply cable to be placed in light transmitting communication with the light tube L in the sleeve. The light tube L in the sleeve is in light transmitting communication with the probe 11. Because there is not a light bulb in the head of the air/water syringe, there is no worry about the head becoming heated from a light bulb. Further, the lack of a light bulb allows the syringe 1 (i.e., the sleeve, neck, body, and nose) to be autoclaved and/or ultrasonically cleaned without the fear of damaging any parts of the syringe 1.

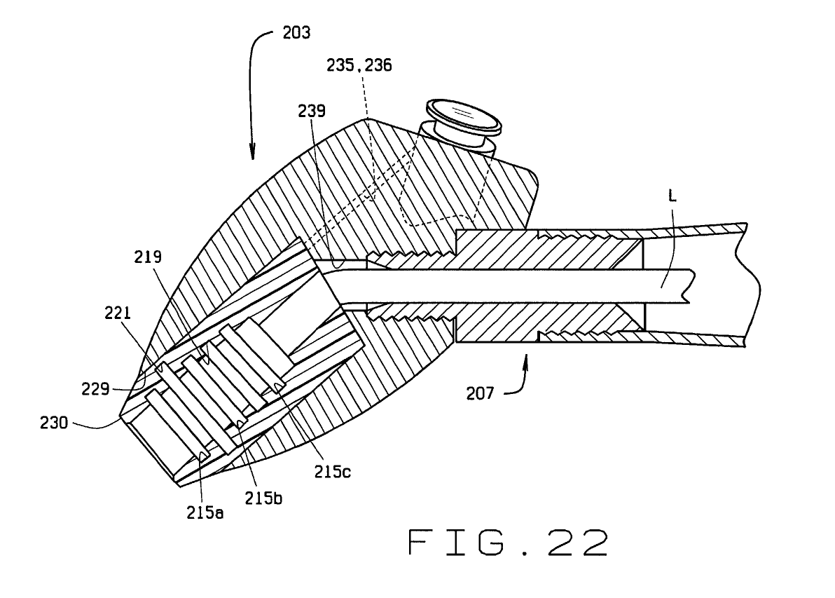

An alternative embodiment of the head 203 is shown in FIG. 22. Rather than having a separate body and nose, as does the syringe head 8 of FIG. 3, the head 203 is a one-piece member which includes both the body and nose. A separate neck 207 is received in the back of the head 203. The neck 207 is threaded at its opposite ends to be threadedly received in the sleeve and in the head.

The head 203 includes passages and chambers substantially identical to the head 8 of FIG. 3. However, as noted, the head 203 does not include a separate nose. Rather, the head 203 has an larger front opening 229 which receives a sleeve 230. The sleeve 230 has an outer surface sized and shaped to be frictionally received in the head front opening 229. Preferably, the opening 229 and the sleeve outer surface are both cylindrical. The sleeve 230 is open in both its front and back to define a passage which is in communication with the head central passage 239. The inner surface of the sleeve passage is provided with three annular grooves 215a,b,c which receive O-rings. Two annular channels 219 and 221 are positioned between the grooves 215a,b,c, such that the channels are separated by the groove 215b. The sleeve 230 additionally includes passages 211 and 213 which extend from the back surface of the sleeve and intersect with the channels 219 and 221, respectively. When the sleeve 230 is inserted in the head 203, the sleeve channels 219 and 221 line up with the body passages 235 and 236. The sleeve 230 is preferably made from a plastic which can withstand autoclaving, but could also be made from any other material which can withstand autoclaving.

As various changes could be made in the above constructions without departing from the scope of the invention, it is intended that all matter contained in the above description or shown in the accompanying drawings shall be interpreted as illustrative and not in a limiting sense. The sleeve 230 of head 203 could be incorporated into the nose 7 of the syringe 1. Thus, the nose 7 would only require a straight bore be formed through the center of the nose, making the nose easier to form from metal stock. The O-ring grooves 217a-c of the sleeve 230 can be replaced with ribs which would seal against the probe 11. The plunger could be spring biased to its closed position, rather than biased to its closed position by water and air pressure. Alternatively, the plunger could be replaced with other types of valve elements. For example, the valve could include a ball which normally blocks either the inlet to, or the outlet from, the valve chamber, and which is moved to an open position, for example, by a post, when the push button activator is pressed. The valves could also be modified so that they are trigger operated, as opposed to push-button operated. These examples are merely illustrative.

Having thus described the invention, what is claimed and desired to be secured by Letters Patent is:

1. An air/water syringe comprising:
a sleeve carrying an air supply line, a water supply line, and a light tube;
a head on said sleeve having an air passage and a water passage and push button actuated valves in said air and water passages; said head air and water passages being in fluid communication with said sleeve air and water lines; said valves each being selectively movable between a closed position in which air or water cannot pass through the respective passage and an opened position in which air or water can pass through the respective passage; said head further including a passage in light transmitting communication with said light tube; and
a probe on an end of said head; said probe having air and water passages extending from an entrance ports in said probe to an exit of said probe at an end of said probe; said entrance ports to said air and water passages of said probe being positioned in a side surface of said prove and being fluid communication with the air and water passages, respectively, of said head; said probe being made of a light transmitting material and being in light transmitting communication with said light tube through said head.

2. The air/water syringe of claim 1 wherein said probe is made from a lens quality polycarbonate.

3. The air/water syringe of claim 1 wherein said probe is disposable.

4. The air/water syringe of claim 1 wherein said probe is formed by cutting a length of an extruded piece of light transmitting material to a desired size, said air and water passages being formed in said material as extruded; sealing one end of said cut length to close the passages at said one end; and, forming said entrance ports in said cut length.

5. The air/water syringe of claim 1 wherein the cut length of extruded material is sealed using a sealant having substantially the same refractive index as the extruded material.

6. The air/water syringe of claim 1 wherein said head includes a probe chamber sized and shaped to frictionally receive said probe; said probe chamber having an inner surface, a first annular channel in fluid communication with said head water passage and a second annular channel in fluid communication with said head air passage, and seals on opposite sides of said first and second annular channels; said first and second annular channels being in fluid communication with the entrance ports to the water and air passages, respectively of said probe when said probe is placed in said probe chamber.

7. The air/water syringe of claim 6 wherein said probe is rotatable in said probe chamber to a selected rotational position relative to said head.

8. The air/water syringe of claim 6 wherein said seals comprise O-rings received in O-ring grooves in said forward opening inner surface.

9. The air/water syringe of claim 6 wherein said head includes a forward opening and a hollow sleeve which is received in said head forward opening; said sleeve defining said probe chamber; said sleeve including water and air passages which place said first and second annular channels in fluid communication with the water and air passages of said head.

10. The air/water syringe of claim 1 wherein said head has an curved outer surface in cross-section and a back surface; said back surface being off-set from a vertical plane which transects said head.

11. The air/water syringe of claim 10 wherein said back surface defines an angle of about 120° with an axial axis of said head.

12. The air/water syringe of claim 10 wherein said valves include push button actuators, said push button actuators being on said head back surface; said actuators having axes which are off-set from both a horizontal and vertical plane of said head, and define an angle with each other.

13. The air/water syringe of claim 12 wherein the push button actuator axes define an angle of about 25°-30 ° with each other.

14. The air/water syringe of claim 12 wherein the push button actuator axes define an angle of about 30° with the horizontal plane of the head.

15. The air/water syringe of claim 1 including a neck extending from said head; said neck being received on said sleeve to mount said head to said sleeve; said neck including an air passage and a water passage in fluid communication with said air and water lines, respectively in said sleeve; said head including valve chambers in a surface of said head; said valve chambers receiving said valves and being in fluid communication with said sleeve air and water passages and said head passages.

16. The air/water syringe of claim 15 wherein said valve chambers are angled with respect to each other; said valve chambers each including a lower section and an upper section; said neck intersecting said head generally in a radial center of said head; said valve chamber lower sections being disposed on opposite sides of said neck; said neck passages including exit ports in communication with said valve chamber lower sections; said neck exit ports being in a side surface of said neck.

17. An air/water syringe comprising:
a sleeve carrying an air supply line, a water supply line;
a head having a nozzle at a forward end thereof and a neck, said neck being connected to said sleeve;
said neck having an air passage in communication with said air supply line and a water passage in communication with said water line;
said head including a side surface; a front surface from which said nozzle extends, and a back surface which is sloped relative to an axial axis of said head, a water valve chamber in communication with said neck water passage, an air valve chamber in communication with said neck air passage, a head water passage extending from said water chamber and in communication said nozzle, a head air passage extending from said air chamber and in communication with said nozzle, an air valve in said air chamber movable between an open position in which air can pass from said air supply line to said head air passage and a closed position in which air is prevented from passing from said air supply line to said head air passage; and a water valve in said water chamber movable between an open position in which water can pass from said water supply line to said head water passage and a closed position in which water is prevented from passing from said water supply line to said head water passage; and
said nozzle including a water passage in communication with said head water passage and an air passage in communication with said head air passage.

18. The air/water syringe of claim 17 wherein said valve chambers are angled with respect to each other; said valve chambers each including a lower section and an upper section; said valve chamber lower sections being disposed on opposite sides of said neck; said neck passages including exit ports in communication with said valve chamber lower sections; said neck exit ports being in a side surface of said neck.

19. The air/water syringe of claim 17 wherein said back surface is sloped.

20. The air/water syringe of claim 19 wherein said back surface defines an angle of about 120° with an axial axis of said head.

21. The air/water syringe of claim 19 wherein said valve chambers are offset from both a horizontal plane of said head, and are angled downwardly.

22. The air/water syringe of claim 21 wherein the push button actuator axes define an angle of about 30° with the horizontal plane of the head.

23. The air/water syringe of claim 17 wherein said valve chambers each include an upper section and a lower section; said chamber lower sections being in communication with said sleeve passages and said chamber upper sections being in communication with said head passages; said valves each including a body having a head external of said head, a neck depending from said head, a sloped section depending from said neck; and a generally straight sided section depending from the sloped section; said straight sided section having a width substantially equal to the width of said chamber; said valve body being movable between a first raised position in which said valve body straight section block the entrance from said valve chamber to said head passage and a second lowered position in which said conical section is in fluid communication with a port between said neck passage and said chamber lower section to place said neck passage and said head passage in fluid communication with each other.

24. The air/water syringe of claim 23 wherein said valve bodies are normally biased to their said first, raised, positions by pressure in said neck air and water passages.
